(19) United States
(12) Patent Application Publication
(10) Pub. No.: US 2006/0049633 A1
(43) Pub. Date: Mar. 9, 2006

(54) Faucet anchor for interconnecting a faucet to the water supply

(76) Inventor: Randolph McBride, Indianapolis, IN (US)

Correspondence Address: THE INVENTORS NETWORK, INC., 332 ACADEMY STREET, CARNEGIE, PA, 15106, US

(21) Appl. No.: 10/936,387

(22) Filed: Sep. 9, 2004

(51) Int. Cl. F16L 15/00

(52) U.S. Cl. 285/390

(57) ABSTRACT

A faucet anchor for attaching the faucet to a sink or cabinet, and for interconnecting the faucet to the water supply includes an elongated hexagonal-shaped body having a head end and an opposite tail end and a passageway extending through the body from the head end to the tail end. The head end includes internal threads for securement to the downwardly projecting inlet of the faucet and the tail end includes external tapered threads for securement to the flexible hose that goes to the water supply. The faucet anchor can come in variable lengths to accommodate both shallow sinks and washbasins and deeper sinks and washbasins.

### FIELD OF THE INVENTION

The present invention pertains to plumbing fixtures and installation, and more particularly pertains to a faucet anchor for interconnecting a faucet to a water supply.

### BACKGROUND OF THE INVENTION

The installation, repair, renovation and replacement of plumbing fixtures most often requires the services of a certified plumber or at the very least the services of an individual with many years experience in home repair and remodeling. This is the case even for such ostensibly simple plumbing fixtures as hot and cold-water faucets for sinks, cabinets, washrooms and washbasins. For the great majority of bathroom and kitchen sinks, for example, the working space for installing a new faucet or replacing an old faucet involves working in a close, cramped and confined space. The faucet is mounted to the upper surface of the sink by either a standard hex nut or a plastic wing nut that is secured to an inlet that downwardly projects from the underside of the sink in the very tight and close space between the sink basin or bowl and the back wall. The professional must lie on his back and maneuver himself beneath the sink or partially within the cabinet while rust flakes fall on his head and struggle to loosen and remove the hex or wing nut. A special tool (though not a very effective tool) is sometimes used to reach the hex nut or wing nut, but the tool in no way overcomes the difficult and awkward manipulations that must be undertaken to reach and dislodge the hex or wing nut when installing a new faucet or replacing an old faucet. Because of the mechanical ability required to accomplish this task, and the physical manipulations required in such a tight, cramped difficult work space, the average homeowner is dissuaded from such work and thus must hire a skilled professional thereby expending time and money. In order to surmount this problem, the prior art reveals a variety of kits, devices and systems for connecting, joining and supporting conduit, tubing, fluid lines and water supply assemblies.

For example, the Guhman patent (U.S. Pat. No. 3,796,202) discloses a choke tube repair system that includes an elongated member having a breakaway collar to facilitate its placement within the stub of the broken choke tube.

The Myers patent (U.S. Pat. No. 3,874,713) discloses a coupling apparatus for pipes that includes seal rings and spring clips for joining together fluid bearing pipes.

The Johnson patent (U.S. Pat. No. 4,589,688) discloses a plumbing hookup kit that includes flexible supply tubing, sealing rings, and adaptor sleeves for making the water supply connection for variously sized fixtures.

The Hille patent (U.S. Pat. No. 4,747,802) discloses a resilient line shaft coupling that includes a pair of hubs joined to a hollow shaft by resilient links that are bolted to a hub flange and a shaft flange thereby allowing parallel and angular misaligments of the hubs.

The Richards patent (U.S. Pat. No. 4,858,860) discloses a pipe hanger that includes a circular-shaped saddle through which the pipe extends and a bolt inserted through the arms of the saddle for tightening the saddle about the pipe.

The Mulvey patent (U.S. Pat. No. 5,024,419) discloses a faucet connector assembly that includes a flexible braided hose having a water supply fitting assembly at one end and a universal faucet fitting assembly at the other end for interconnecting the faucet to the water supply.

The Pan patent (U.S. Pat. No. 5,199,746) discloses connector structure for mixed—type faucets that includes a z-shaped connecting pipe and accompanying o-rings and sealing gaskets for interconnecting mixed-type faucets to the water supply.

The Harbin patent (U.S. Pat. No. 5,362,111) discloses an anti-rotation locking device that includes a spring clip having apertured end portions one of which forms a uni-directional clutch for preventing the rotation of the coupling nut and fluid line.

The Ko patent (U.S. Pat. No. 5,516,155) discloses a water pipe connecting structure that includes a locking nut, a coupling pipe, a connecting pipe, a metal fastening sleeve and a conic watertight washer.

The Hoff patent (U.S. Pat. No. 5,605,359) discloses a hose fitting for a coupling that includes an anti-rotation collar for attachment to the tube of a push-to-connect coupling assembly for preventing the rotation of the collar relative to the tube.

Despite the ingenuity of the above devices, there remains a need for a faucet anchor or connector that attaches to all types of faucets easily, quickly and with a minimum of specialized tools, training and skill.

### SUMMARY OF THE INVENTION

The present invention comprehends a faucet anchor for securing the faucet to a kitchen or bath cabinet or sink, and for interconnecting the faucet to the flexible hose that connects to the water supply. The faucet anchor includes an elongated hexagonal-shaped body having a head end and an opposite tail end and a passageway extending through the body from the head end to the tail end. The head end includes internal threads so that the head end can be secured to the downwardly extending inlet of the faucet and the tail end includes regular tapered pipe threads for connection to the threaded portion or connector nut of the flexible hose. The faucet anchor can come in variable lengths so that the faucet anchor can be used with faucets mounted on shallow sinks, cabinets, or washbasins and with faucets mounted on deeper sinks, cabinets, or washbasins. The faucet anchor is a one-piece component to facilitate the interconnection of the faucet to the sink and the water supply by anyone, and without the use of specialized tools or training.

It is an objective of the present invention to provide a faucet anchor that allows the individual homeowner to easily and effortlessly install a faucet on a sink or cabinet that may be a shallow sink or a deeper sink.

It is another objective of the present invention to provide a faucet anchor that allows the homeowner to install a faucet without the need for having special plumbing skills thereby saving both time and expense in installation.

It is yet another objective of the present invention to provide a faucet anchor that is a one-component item for facilitating ease and efficiency of installation of the faucet.

It is still yet another objective of the present invention to provide a faucet anchor that does not require the use of any special tools for installation of the faucet anchor to the faucet and the flexible hose.

Another objective of the present invention is to provide a faucet anchor that comes in variable lengths so that the faucet anchor can be used in different locations and with various types of faucet and plumbing fixtures.

Still another objective of the present invention is to provide a faucet anchor that allows homeowners, do-it-yourselfers, women and those of teenage years to install a faucet without having specialized plumbing and mechanical training and skills.

Still yet another objective of the present invention is to provide a faucet anchor that replaces the difficult to access standard hex nut that normally attaches the faucet to the sink or cabinet.

Yet a further objective of the present invention is to provide a faucet anchor wherein the only tool needed for attaching the faucet anchor to the faucet and the flexible hose is a standard adjustable crescent wrench.

These and other objects, features, and advantages will become apparent to one skilled in the art upon a perusal of the following detailed description read in conjunction with the accompanying drawing figures.

### BRIEF DESCRIPTION OF THE DRAWINGS

FIG. 1 is a side elevational view of the faucet anchor of the present invention illustrating the interconnection of the faucet to the sink and the flexible hose for the water supply for a deeper sink.

FIG. 2 is a side elevational view of the faucet anchor of the present invention illustrating the interconnection of the faucet to the sink and the flexible hose for the water supply for a shallow sink; and

FIG. 3 is a perspective view of the faucet anchor of the present invention.

### DETAILED DESCRIPTION OF THE PREFERRED EMBODIMENT

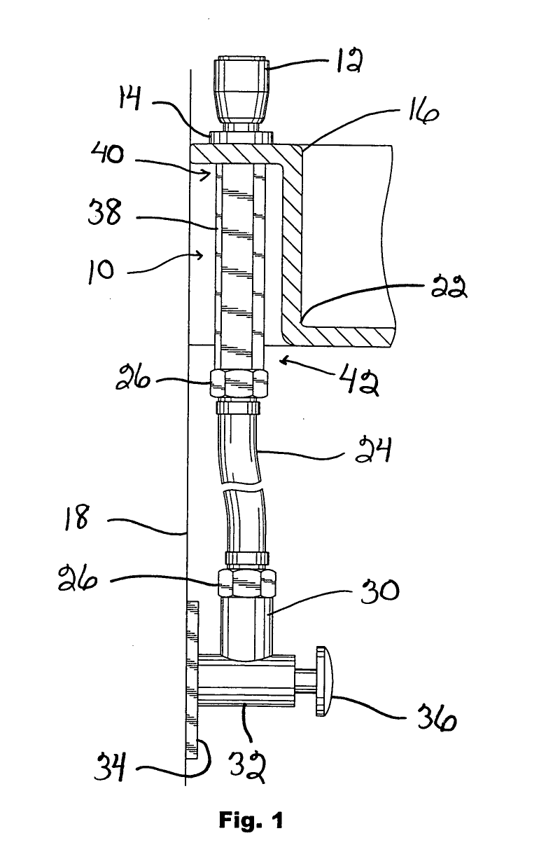

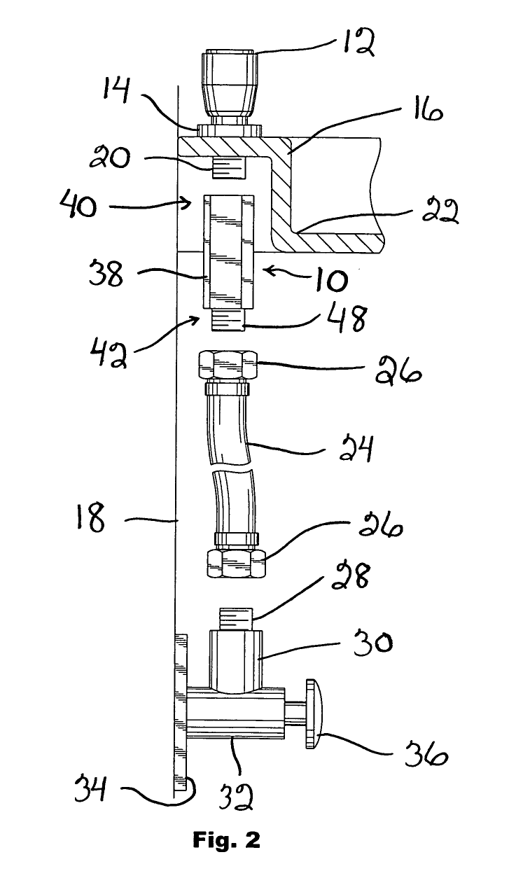

Illustrated in FIGS. 1-3 is the preferred embodiment of a faucet anchor 10 that is used to interconnect a faucet to the flexible hose, that, in turn, is interconnected to the water supply line and system of a home or other structure. While plumbing fixtures for faucets and their hook-ups may vary, a representative plumbing arrangement is shown in FIGS. 1 and 2. Thus, a faucet 12 is shown supported on a base plate 14 and mounted to a sink or washbasin 16. The sink 16 abuts and is mounted to a back wall 18, and in FIG. 1 the sink 16 is shown as a deeper sink while in figure two the sink 16 is shown as a shallow sink. The faucet 12 includes an inlet 20 that projects downwardly beneath the sink 16 in the narrow space confined between the back wall 18 and the sink basin 22. The inlet 20 is externally threaded and normally a ¼ inch hex nut or plastic wing nut (not shown) is secured to the inlet 20 for attaching the faucet 10 to the sink 16. Disposed beneath the inlet 20 and for securement thereto is a flexible hose 24; but by supplanting the hex or wing nut, the faucet anchor 10 both attaches the faucet 12 to the sink 16, and provides for the attachment of the hose 24 to the faucet anchor 10 as will be hereinafter further described. At each end of the flexible hose 24 is a connecting fixture or nut 26 so that one hose end can be attached to the faucet anchor 10 and the other hose end can be attached to the threaded end 28 of the lateral outlet 30 of the pipe or conduit 32 that connects to the water supply (for example, the hot water tank). The conduit 32 projects from the back wall 18 and is held in position by a mounting plate 34, and the conduit 32 includes an internal shut off valve (not shown) that is controlled by a manually rotatable handle 36 that opens and closes the shut off valve.

Thus, as shown in FIGS. 1 through 3, the faucet anchor 10 is interposed between, and connected to, the water inlet 20 of the faucet 10 and the flexible hose 24 thereby interconnecting the faucet 12 to the water supply of the house. The faucet anchor 10 includes an elongated hexagonal-shaped body 38 preferably manufactured and formed from galvanized metal stock. One preferred diameter of the body 38 is 1 and ¼ inches. Other materials of composition may be brass, steel, and plastic. The body 38 includes a head end 40 that is connected to the water inlet 20 of the faucet 12 and an opposite tail end 42 that is attached to the connecting nut 26 of the flexible hose 24. A passageway or bore 44 extends completely through the body 38 from the head end 40 to the tail end 42 for conveying water from the water supply to the spigot(s) (not shown) of the faucet 12.

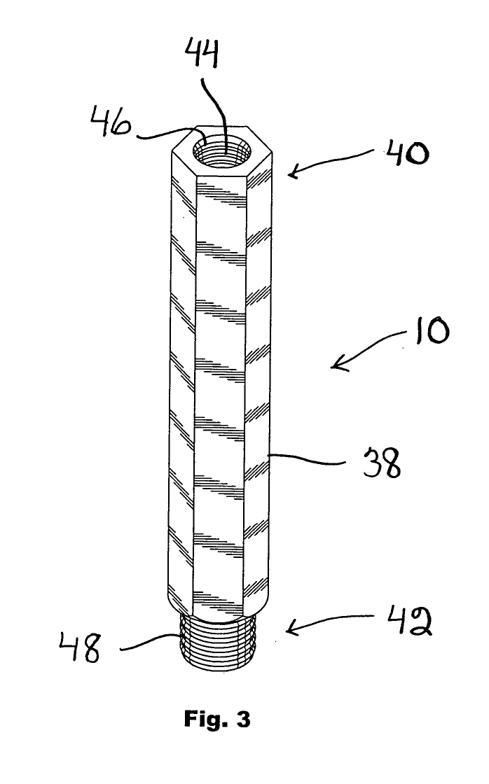

As shown most clearly in FIG. 3, the head end 40 of the body 38 includes internal threads 46 with the internal threads 46 preferably extending or running approximately 1 and ½ inch within the bore 44. In addition, the tail end 42 of the body 38 includes annular and externally tapered threads 48—that can be external pipe threads—with the diameter of the externally threaded portion at the tail end 42 being less than the diameter of the body 38 of the faucet anchor 10. While the faucet anchor 10 can come in many lengths, two preferred lengths are ten inches to accommodate the sink 16 having a deeper basin 22 as shown in FIG. 1, and eight inches to accommodate the sink 16 with the shallower basin 22 as shown in FIG. 2. Both faucet anchor 10 lengths will allow the homeowner or the professional to simply reach and “feel” their way in the confined space for mounting and securing the faucet anchor 10 in place.

Thus, the faucet anchor 10 of the present invention replaces the standard ¼ inch hex nut or wing nut so that the individual can mount the faucet 12 to the kitchen or bath cabinet or sink 16; and the faucet anchor 10 also provides for the connection of the faucet 12 to the flexible hose 24 which, in turn, connects to the water supply system via the lateral outlet 30 of the pipe 32. A simple method of installing a new faucet or replacing an old faucet is to first properly position the faucet 12 on the sink 16 and in alignment with the base or mounting plate 34. Reaching and feeling underneath the sink 16 the individual would then screw the head end 40 of the faucet anchor 10 onto the inlet 20 of the faucet 12 using a standard adjustable crescent wrench to tighten the faucet anchor 10 thereon. Then the connecting nut 26 of the flexible hose 24 would be attached to the tapered threads 48 at the tail end 42 of the faucet anchor 10 thereby easily and conveniently interconnecting the faucet 12 with the water supply system.

Although a preferred embodiment of the invention has been shown and described, it will be understood that numerous modifications, alterations, or variations can be made by those skilled in the art without departing from the spirit of the invention and the scope of the appended claims.

I claim:

1. A faucet anchor, comprising:
an elongated body of hexagonal cross section;
the elongated body having a head end and an opposite tail end;
a passageway extending through the body from the head end to the tail end;
the passageway including a plurality of internal threads located adjacent the head end;
the tail end including a plurality of external tapered threads; and
the tail end being cylindrical-shaped.

2. The faucet anchor of claim 1 wherein the faucet anchor can be composed of metal.

3. The faucet anchor of claim 2 wherein the faucet anchor can be composed of steel.

4. The faucet anchor of claim 3 wherein the faucet anchor can be composed of brass.

5. The faucet anchor of claim 4 wherein the faucet anchor can be composed of plastic.

6. The faucet anchor of claim 5 wherein the faucet anchor can have a length of between eight and ten inches.

7. A faucet anchor for interconnecting the water inlet of a faucet to the flexible hose for the water supply, comprising:
an elongated body having a hexagonal cross section;
the body including a head end and an opposite tail end;
a passageway extending through the body from the head end to the tail end;
the passageway including a plurality of internal threads located adjacent the head end for securement to the water inlet of the faucet;
the tail end including a plurality of tapered threads for securement to the flexible hose of the water supply; and
the tail end being cylindrical-shaped.

8. The faucet anchor of claim 7 wherein the body can be manufactured from steel.

9. The faucet anchor of claim 8 wherein the body can be manufactured from brass.

10. The faucet anchor of claim 9 wherein the body can be manufactured from metal.

11. The faucet anchor of claim 10 wherein the body can be manufactured from plastic.

12. The faucet anchor of claim 11 wherein the body can have a length of between eight and ten inches.
